(19) United States
(12) Patent Application Publication
(10) Pub. No.: US 2022/0092600 A1
(43) Pub. Date: Mar. 24, 2022

(54) System for Credit Card, Debit Card, and Voting Fraud Prevention

(71) Applicant: Rodney Teansky, Delta, CO (US)

(72) Inventor: Rodney Teansky, Delta, CO (US)

(21) Appl. No.: 17/400,327

(22) Filed: Aug. 12, 2021

Related U.S. Application Data
(60) Provisional application No. 63/204,201, filed on Sep. 18, 2020.

(51) Int. Cl. G06Q 20/40; G06Q 50/26

(52) U.S. Cl. CPC G06Q 20/4016; G06Q 2230/00; G06Q 50/26; G06Q 20/40145

(57) ABSTRACT

A computer implemented fraud application prevention system is described. The fraud application prevention system can be utilized for credit cards or debit cards. The same computer implemented application that is usable for credit cards or debit cards can also be used to identify an eligible voter and to prevent voter fraud. The application requires biometrics. Each time a credit card or debit card is used for a purchase or to withdraw cash, whether using a physical card or online by entering in any details associated with the card, the user is required to provide the registered biometrics before any purchase or use is authorized. For a voter, the user registers his or her biometrics and a voter ID number. The voter is identified by the voter ID number and the biometrics before being provided with a voting ballot for any local, state, or federal election.

### CROSS-REFERENCE TO RELATED APPLICATIONS

This application is a non-provisional application which claims priority to U.S. Provisional Patent Application No. 63/204,201 filed on Sep. 18, 2020, which is incorporated by reference in its entirety.

### FIELD OF THE DISCLOSURE

This disclosure generally relates to a computer implemented system to prevent fraudulent and unauthorized use of credit cards, whether when using a physically tangible credit card or making an online purchase in which credit card numbers are entered in online. The computer implemented system further prevents fraudulent voting.

### BACKGROUND

Fraudulent use of credit cards is known to be an ongoing and serious problem for individuals and institutions that represent them. Credit card fraud is the unauthorized use of a credit or debit card which may happen when an unauthorized person or group of people gains access to one's information and uses it to make purchases or similar payment transfers (ACH, EFT, recurring charge, etc.), to fraudulently obtain money or property. Even with current efforts to minimize credit card fraud, it is still an ongoing problem that individuals will frequently experience credit card fraud and misuse. Very few stores and other locations where items are available for purchase even request identification anymore when a credit card or debit card is provided so one is not able to count on the need for having physical identification such as a driver's license, membership card, or some other form of identification being usable to identify the authorized user from unauthorized users.

There is a variety of ways in which credit and debit card numbers can be stolen. For example, credit card fraud can happen if someone physically steals one's credit or debit card and retains access to the physical card that he or she can easily utilize at a variety of places to make unauthorized purchases. There are a variety of ways in which criminals and fraudsters obtain one's information including via lost or stolen credit cards, skimming one's credit card, such as at a gas station pump, hacking one's computer, calling about fake prizes or wire transfers, phishing attempts, such as fake emails, or even stealing one's mail or observing any pin numbers that are entered by an authorized user during checkout.

Many credit cards today come with some security features which are supposed to provide a little more security and attempts to prevent counterfeit and fraudulent transactions. However, they are still insufficient as millions of people suffer from the headaches and difficulty that comes with credit card theft and any associated identity theft that follows.

Voter fraud is also of increasing concern for a variety of reasons. It has come to light, in particular in the United States, but also in many regions of the world that voter fraud may occur because individuals want to skew the results of an election, but more commonly, foreign governments have tried to interfere with local, state, and federal elections as well. There is as much a need to prevent credit card fraud as there is to prevent voter fraud in the United States and elsewhere. One or more systems described herein may address these and other issues.

### SUMMARY

One or more embodiments are provided for a computer implemented system for card fraud prevention and voter fraud prevention. The computer implemented system may be used for either an online or onsite purchase or other use of a credit card or debit card. The computer implemented system may include a computing device having a display screen, one or more memory, and one or more processors. The one or more processors may be configured to provide a fraud prevention application that is downloadable or stored on a user computing device. A first biometric and a second biometric may be captured using one or more biometric scanning mechanisms from a user. The one or more biometric scanning mechanisms are connectable or otherwise interactable with the user computing device. The first biometric and the second biometric may be stored in accessible storage or otherwise associated with the fraud prevention application. The first biometric and the second biometric may be registered with a card issuer for a credit card or a debit card upon activation of the credit card or the debit card, further comprising associating the first biometric and the second biometric with the credit card or the debit card. Upon request by a card issuer responding to a request to use the credit card or the debit card online for an online purchase or other use, the first biometric may be provided to the card issuer prior to authorizing the online purchase or other use of the credit card or debit card. If the first biometric fails to be approved, the second biometric may be provided to the card issuer prior to authorizing the online purchase or other use of the credit card or debit card.

The fraud prevention application may be utilized to prevent voter fraud by associating a voter identity for the use with the first biometric and the second biometric stored in the fraud prevention application. This exemplary method may further include associating the first biometric and the second biometric with a voter ID assigned to the user. The user may be provided a ballot to vote in person or remotely. When the first biometric provided matches with an entered voter ID, the user may be authorized to vote via the ballot. If the first biometric is not approved, the second biometric may be provided. The voting may be then authorized for the user via the ballot upon matching of the entered voter ID and matching of the first biometric or the second biometric.

Other aspects and advantages of the invention will be apparent from the following description and the appended claims.

### BRIEF DESCRIPTION OF THE DRAWINGS

The preceding and following embodiments and descriptions are for illustrative purposes only and are not intended to limit the scope of this disclosure. Other aspects and advantages of this disclosure will become apparent from the following detailed description.

Embodiments of the present disclosure are described in detail below with reference to the following drawings. The drawings described herein are for illustrative purposes only of selected embodiments and not all possible implementations and are not intended to limit the scope of the present disclosure.

FIG. 1 is a block diagram depicting computing devices, components, and systems for implementing a fraud prevention system for both credit card fraud and voter fraud in accordance with one or more illustrative embodiments.

FIG. 2 is another block diagram of components of a computer implemented system for credit card and voter fraud prevention in accordance with an illustrative embodiment.

FIG. 3 is a flowchart for an exemplary method of activating a credit card or a debit card using the fraud prevention application.

FIG. 4 is a flowchart for an exemplary method of conducting an onsite purchase using a credit card or debit card.

FIG. 5 is a flowchart for an exemplary method of conducting an online purchase using a credit card or debit card.

FIG. 6 is a flowchart for an exemplary method of registering a voter using the fraud prevention application to prevent voter fraud.

FIG. 7 is a pictorial illustration of an exemplary card reader with a biometric scanning device usable for purchases or other authorized use of a credit or debit card.

### DETAILED DESCRIPTION

In the Summary above and in this Detailed Description, and the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with; and/or in the context of other particular aspects and embodiments of the invention; and in the invention generally.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

“Exemplary” is used herein to mean “serving as an example, instance, or illustration.” Any aspect described in this document as “exemplary” is not necessarily to be construed as preferred or advantageous over other aspects.

The term “set” as used herein may refer to one or more. Accordingly, a set may include one item or several items.

Throughout the drawings, like reference characters are used to designate like elements. As used herein, the term “coupled” or “coupling” may indicate a connection. The connection may be a direct or an indirect connection between one or more items. Further, the term “set” as used herein may denote one or more of any items, so a “set of items” may indicate the presence of only one item or may indicate more items. Thus, the term “set” may be equivalent to “one or more” as used herein.

As noted above, credit card and debit card fraud is an ongoing issue of serious concern for many people worldwide. Further, voter fraud is also of concern and can impact local, state, and federal elections in a very negative manner. When voter confidence in the accuracy and authenticity of voter results is low, the turnout to vote is also negatively affected. It is important to have a new and improved system that can be used by the same user from the same computing device for preventing credit card and debit card fraud as well as voter fraud. Further details are provided below with respect to the Figures.

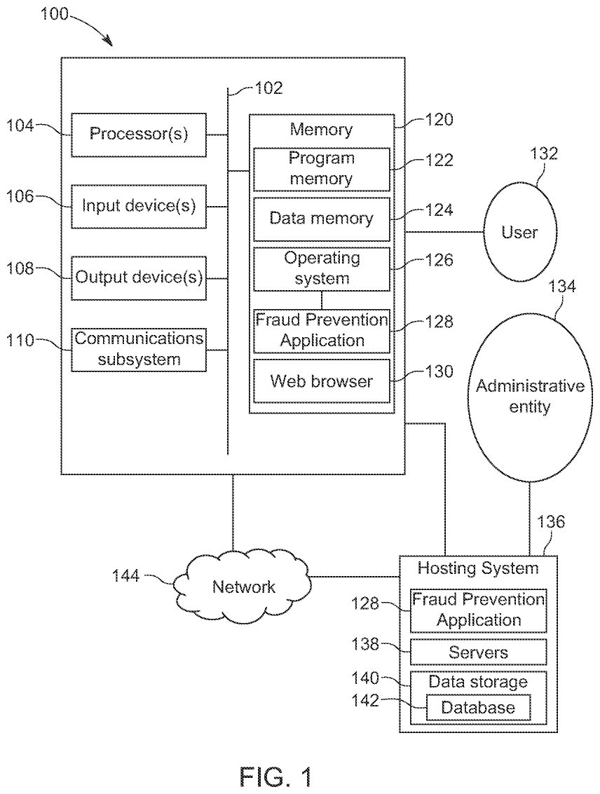

Turning to FIG. 1, FIG. 1 illustrates an exemplary system for one or more computing devices and the various exemplary components that may be employed in practicing one or more non-limiting embodiments of the invention as described herein. Computing device 100 may be any type of computing device known or to be created in the future. This may include, without limitation, fixed in place computers, such as desktop computers or mobile computing devices. Mobile computing devices may include, but are not limited to, laptop computers, smartphones and mobile phones, tablets, wearable electronic computing devices such as watches or glasses, or any other type of mobile electronic, computing device.

FIG. 1 provides a schematic illustration of one embodiment of a computing device 100 that can perform the methods provided by the various other listed embodiments, as described herein, and/or can function as the host computer system, a remote kiosk/terminal, a point-of-sale device, a mobile device, a set-top box and/or a computer system. FIG. 1 is meant only to provide a generalized illustration of various components, any or all of which may be utilized as appropriate. FIG. 1, therefore, broadly illustrates how individual system elements may be implemented in a relatively separated or relatively more integrated manner.

Computing device 100 may be any type of information handling system, including, but not limited to, any type of computing device as noted above. To reiterate, this may include small handheld devices, such as handheld computer/mobile telephones or may include large mainframe systems, such as a mainframe computer. Further examples of handheld computing devices may include personal digital assistants (PDAs), personal entertainment devices, such as MP3 players, portable televisions, and compact disc players. Other examples of computing devices 100 may include, but are not limited to, laptops, notebooks, workstation computers, personal computer systems, as well as servers (e.g., servers 138). Computing devices 100 can be used by various parties described herein and may be connected on a computer network, such as computer network 144. Types of computer networks that can be used to interconnect the various information handling systems may include, but are not limited to, Local Area Networks (LANs), Wireless Local Area Networks (WLANs), the Internet (e.g., World Wide Web), the Public Switched Telephone Network (PSTN), other wireless networks, and any other network topology that can be used to interconnect the information handling systems.

The computing device 100 is shown comprising hardware elements that can be electrically coupled via a bus 102 (or may otherwise be in communication, as appropriate). The hardware elements of computing device 100 may include one or more processors 104, including without limitation one or more general-purpose processors and/or one or more special-purpose processors (such as digital signal processing chips, graphics acceleration processors, and/or the like). Computing device 100 may further include one or more input devices 106, which can include without limitation one or more cameras, sensors (including inertial sensors), a mouse, a keyboard, and/or the like, which may be utilized in the implementation of fraud prevention application 128.

In addition to the above, computing device 100 may include one or more output devices 108 such as a device display. Furthermore, in some embodiments, an input device 106 and an output device 108 of computing device 100 may be integrated, for example, in a touch screen or capacitive display as commonly found on mobile computing devices as well as desktop computers and laptops.

Processors 104 may have access to a memory such as memory 120. Memory 120 may include one or more of various hardware devices for volatile and non-volatile storage and may include both read-only and writable memory. For example, memory 120 may comprise random access memory (RAM), CPU registers, read-only memory (ROM), and writable non-volatile memory, such as flash memory, hard drives, floppy disks, CDs, DVDs, magnetic storage devices, tape drives, device buffers, and so forth. A memory 120 is not a propagating signal divorced from underlying hardware; a memory is thus non-transitory. Memory 120 may include program memory such as program memory 122 capable of storing programs and software, such as operating system 126, fraud prevention application 128, and other computerized programs or application programs. Memory 120 may also include data memory such as data memory 124 that may include database query results, configuration data, settings, user options or preferences, etc., which may be provided to program memory 122 or any element of computing device 100.

The computing device 100 may further include (and/or be in communication with) one or more non-transitory storage devices, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like. Device storage may be used in a number of embodiments discussed herein. Further, the storage devices may be non-volatile data storage devices in one or more non-limiting embodiments. Further, computing device 100 may be able to access removable nonvolatile storage devices that can be shared among two or more information handling systems (e.g., computing devices) using various techniques, such as connecting the removable nonvolatile storage device to a USB port or other connector of the information handling systems.

The computing device 100 might also include a communications subsystem 110, which can include without limitation a modem, a network card (wireless or wired), an infrared communication device, a wireless communication device and/or chipset (such as a Bluetooth™ device, an 802.11 device, a WiFi device, a WiMax device, cellular communication facilities, etc.), and/or the like. The communications subsystem 110 may permit data to be exchanged with a network (e.g., such as network 144), other computer systems, and/or any other devices.

The computing device 100 also can comprise software elements, shown as being currently located within the memory 120, which in some instances may include an operating system 126, device drivers, executable libraries, and/or other code, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer). In an aspect, then, such code and/or instructions can be used to configure and/or adapt computing device 100 to perform one or more operations in accordance with the described methods.

A set of these instructions and/or code might be stored on a computer-readable storage medium, such as the storage device(s) described above. In some cases, the storage medium might be incorporated within a computer system, such as computing device 100. In other embodiments, the storage medium might be separate from computing device 100 (e.g., a removable medium, such as a compact disc or USB stick), and/or be provided in an installation package, such that the storage medium can be used to program, configure, and/or adapt a general purpose computer with the instructions/code stored thereon. These instructions might take the form of executable code, which is executable by the computing device 100 and/or might take the form of source and/or installable code, which, upon compilation and/or installation on the computing device 100 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

Some embodiments may employ a computer system (such as the computing device 100) to perform methods in accordance with the disclosure. For example, some or all of the procedures of the described methods may be performed by the computing device 100 in response to one or more processors 104 executing one or more sequences of one or more instructions (which might be incorporated into the operating system 126 and/or other code contained in the memory 120). Such instructions may be read into the memory 120 from another computer-readable medium, such as one or more of the storage device(s). Merely by way of example, execution of the sequences of instructions contained in the memory 120 may cause the one or more processors 104 to perform one or more procedures of the methods described herein.

The terms “machine-readable medium” and “computer-readable medium,” as used herein, refer to any medium that participates in providing data that causes a machine to operate in a specific fashion. In an embodiment implemented using the computing device 100, various computer-readable media might be involved in providing instructions/code to the one or more processors 104 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media may include, for example, optical and/or magnetic disks which may be an example of storage devices. Volatile media may include, without limitation, dynamic memory, which may be a type of memory included in memory 120. Transmission media may include, without limitation, coaxial cables, copper wire and fiber optics, including the wires that comprise the bus 102, as well as the various components of the communications subsystem 110 (and/or the media by which the communications subsystem 110 provides communication with other devices). Transmission media can also take the form of waves (including without limitation radio, acoustic, and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 104 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 100. These signals, which might be in the form of electromagnetic signals, acoustic signals, optical signals, and/or the like, are all examples of carrier waves on which instructions can be encoded, in accordance with various embodiments of the invention.

The communications subsystem 110 (and/or components thereof) generally will receive the signals, and the bus 102 then might carry the signals (and/or the data, instructions, etc. carried by the signals) to the memory 120, from which the one or more processors 104 retrieves and executes the instructions. The instructions received by the memory 120 may optionally be stored on a non-transitory storage device either before or after execution by the processor(s) 104.

In one or more embodiments, computing device 100 is in communication with one or more networks, such as network 144. Network 144 may include a local area network (LAN), such as a company Intranet, a metropolitan area network (MAN), or a wide area network (WAN), such as the Internet or World Wide Web. Network 144 may be a private network, a public network, or a combination thereof. Network 144 may be any type of network known in the art, including a telecommunications network, a wireless network (including Wi-Fi), and a wireline network. Network 144 may include mobile telephone networks utilizing any protocol or protocols used to communicate among mobile digital computing devices (e.g., computing device 100), such as GSM, GPRS, UMTS, AMPS, TDMA, or CDMA. In one or more non-limiting embodiments, different types of data may be transmitted via network 144 via different protocols. In further non-limiting other embodiments, computing device 100 may act as a standalone device or may operate as a peer machine in a peer-to-peer (or distributed) network environment.

Network 144 may further include a system of terminals, gateways, and routers. Network 144 may employ one or more cellular access technologies including but not limited to: 2nd (2G), 3rd (3G), 4th (4G), 5th (5G), LTE, Global System for Mobil communication (GSM), General Packet Radio Services (GPRS), Enhanced Data GSM Environment (EDGE), and other access technologies that may provide for broader coverage between computing devices if, for instance, they are in a remote location not accessible by other networks.

In one or more non-limiting embodiments, a computing device, such as computing device 100 may include a web browser such as web browser 130. Web browser 130 may be any type of web browser known in the art that may be used to access one or more web applications (e.g., fraud prevention application 128) on user computing devices 100 or the like. Web applications are applications that are accessible by network 144 and may be located on the Internet or World Wide Web. Web browser 130 may include a variety of hardware, software, and/or firmware generally operative to present a web application to a user via a display device 108 (e.g., touchscreen or other type of monitor or display device) on a computing device. Examples of suitable web browsers include, but are not limited to, MICROSOFT EXPLORER, MOZILLA FIREFOX, and APPLE SAFARI. Web browser 130 may be previously installed by the manufacturer or company associated with the computing device 100, or alternatively, may be downloaded onto computing device 100 or any other computing device. Web browser 130 may be stored in a separate storage device and/or memory 120.

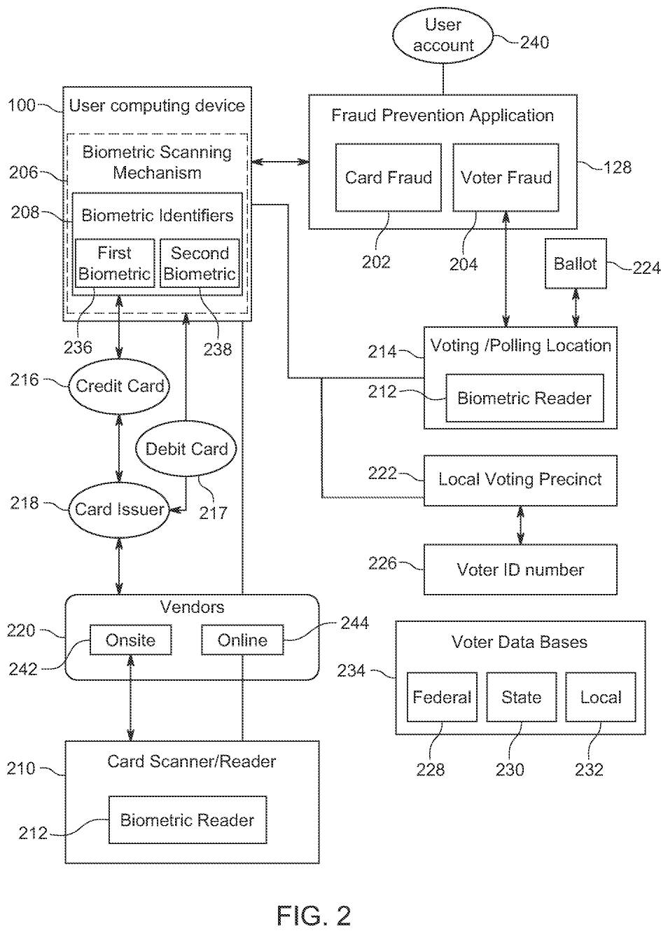

In one or more non-limiting embodiment, fraud prevention application 128 may be a software program or module configured to utilize biometrics (as shown in FIG. 2) to avoid or prevent fraudulent use of credit cards, debit cards, or voter fraud.

In one or more non-limiting embodiments, fraud prevention application 128 may be implemented as a web service. As known in the art, a web service may be a software module or software program (e.g., fraud prevention application 128) that is designed to implement a set of tasks that is accessible from multiple computing devices, such as computing device 100 over a network, such as network 144. In particular, fraud prevention application 128 may be implemented as a web service accessible using the World Wide Web as the connecting network 144, although any alternative type of network may be used. Fraud prevention application 128, when implemented as a web service, can be searched by any user (e.g., user 132) using web browser 130. Fraud prevention application 128 when implemented as a web service can be searched for over the network 144 using the input devices 106 of a computing device and can also be invoked accordingly. Further, fraud prevention application 128 when invoked as a web service would be able to provide functionality to the client or user who invoked that web service.

When fraud prevention application 128 is implemented as a web service, a client or party may invoke a series of web service calls via requests to one or more servers 138 that are part of the hosting system 136 which would host the actual web service. In one or more non-limiting embodiments, hosting system 136 may be a cloud-based type hosting system. “Cloud-based” is a term that refers to applications, services, or resources (e.g., fraud prevention application 128) made available to users on demand via a network, such as network 144, from a cloud computing provider's server. In one non-limiting embodiment, administrative entity 134 may be the cloud computing provider and may use servers 138 to provide access to fraud prevention application 128.

Hosting system 136 may include data storage systems 140 that can provide access to stored data by applications running on computing devices (e.g., 100) that may be geographically separate from each other, provide offsite data backup and restore functionality, provide data storage to a computing device with limited storage capabilities, and/or provide storage functionality not implemented on a computing device (e.g., 100).

The hosting system 136 may be a service that can be implemented as a web service, in one or more non-limiting embodiments, with a corresponding set of Web Service Application Programming Interfaces (APIs). The Web Service APIs may be implemented, for example, as a Representational State Transfer (REST)-based Hypertext Transfer Protocol (HTTP) interface or a Simple Object Access Protocol (SOAP)-based interface. Any programming languages may be used to create or operate fraud prevention application 128 as a web service, including, but not limited to .Net, Java, and XML. Further, fraud prevention application 128 as a web service may use standardized industry protocol for the communication and may include well-defined protocols, such as Service Transport, XML Messaging, Service Description, and Service Discovery layers in the web services protocol stack.

For instance, the hosting system can be implemented such that client applications (for example, executing on computing device 100) can store, retrieve, or otherwise manipulate data objects in the hosting system 136. The hosting system 136 can be implemented by one or more server devices 138, which can be implemented using any type of computing device.

In one or more non-limiting embodiments, administrative entity 134 is the provider and creator of fraud prevention application 128. Administrative entity 134 may provide the application programming interface (e.g., fraud prevention application 128) for use by user 132. Administrative entity 134 may be able to manipulate and alter fraud prevention application 128 to affect the operation and maintenance of fraud prevention application 128 on server(s) 138 and as stored on one or more data storage devices 140 that are part of the hosting system 136. Data storage devices 140 included for storing any data associated with fraud prevention application 128 may include one or more databases 142 that store live and historical sensor data in one or more non-limiting embodiments. Data storage devices 140, via databases 142 in some cases, may be able to store all data obtained from user 132, such as the biometrics shown in FIG. 2. While administrative entity 134 is depicted as a single element communicating over network 144 and through the hosting system 136, it is noted that administrative entity 134, in one or more non-limiting embodiments, may be distributed over network 144 in any number of physical locations.

In one or more non-limiting embodiments, fraud prevention application 128 may alternatively be a downloadable software module that is capable of being stored directly on a computing device, such as computing device 100, rather than acting as a web service accessible through a computing device's web browser 130. Accordingly, any user may be able to download and store fraud prevention application 128 on computing device 100 as a computer based application and software module that runs using the working engines and modules on the computing device. In some embodiments, fraud prevention application 128 may be preinstalled on computing device 100 or any other computing device by the manufacturer or designer or other entity. Fraud prevention application 128 may be innate, built into, or otherwise integrated into existing platforms such as, without limitation thereto, a website, third-party program, iOS™ Android™, Snapchat™, Getty Images™, Instagram™, Facebook™, or any other platform capable transmitting, receiving, and presenting data.

Fraud prevention application 128 may be stored on computing device 100 or any other computing devices and may also be stored or otherwise accessible by one or more servers 138 over network 144 by any party. The storage devices may include a non-transitory computer readable medium including instructions, which when executed by a computer or processor (such as processors 104) may cause the computer or processor to perform operations to implement fraud prevention application 128. Additionally, or alternatively, fraud prevention application 128 may be a software application that is downloadable and usable from any type of mobile computing device 100.

As shown in FIG. 1, computing device 100 may belong to a user referred to in FIG. 1 such as user 132. User 132 may be a user that intends to access fraud prevention application 128 using his or computing device 100.

As noted above, in one non-limiting embodiment, fraud prevention application 128 may be implemented as a web service as described above. Accordingly, fraud prevention application 128 may be accessed by any party, including user 132, over the computer network 144 using their web browsers 130 to use any features included with fraud prevention application 128. Further information about other components of fraud prevention application 128 are included below with respect to FIG. 2-FIG. 7.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, some embodiments are described as processes depicted as flow diagrams or block diagrams. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

Turning to FIG. 2, FIG. 2 is a block diagram of various components that may be included in one or more embodiments of a computer based application, such as fraud prevention application 128. Fraud prevention application 128 allows a user to take steps to prevent card fraud 202 from occurring when unauthorized users are able to access their credit card or debit card information. Further, fraud prevention application 128 allows the same user to take steps to prevent voter fraud 204. Thus, the same fraud prevention application 128 may have a user account that stores biometric identifiers or biometrics 208 for the user 132 that may be utilized to prevent card fraud 202, including credit and/or debit card fraud, as well as to prevent any voter fraud 204

A credit card 216 associated with user 132 may be an authorized credit card issued by a card issuer 218 and allows the user 132 to purchase goods or services via credit. A debit card, such as debit card 217, may be issued by a same or different card issuer 218, and requires withdrawal of funds from a user's 132 checking or other type of account rather than allowing the user 132 to purchase goods or services via credit. A card issuer 218 may be any type of card agency, institution, or organization issuing credit cards 216 and/or debit cards 217.

Fraud prevention application 128 utilizes biometric identifiers 208 unique to the user 132, as shown in FIG. 1, to be associated with each credit card 216 and debit card 217 of the user 132. Biometric identifiers 208 are unique physical characteristics, such as fingerprints, that can be used for automated recognition in place of a physical identification card, such as a driver's license or another physical identification card. Examples of biometric identifiers 208 include, but are not limited to, fingerprints, eyes or irises, voice, face shape and structure, ear shape and structure, DNA, retina, and gait. In a non-limiting embodiment, the user computing device 100 may include one or more biometric scanning mechanisms 206 capable of recognizing and obtaining biometric identifiers 208 from the user 132. In another embodiment, the biometric scanning mechanism 206 may be a third party device not integrated with the user computing device 100 but may be connected to the user computing device 100 using one or more wired connections or wireless connections. Further, the biometric scanning mechanism 206 may be its own computer application that may be downloaded onto the user computing device 100 in one or more non-limiting embodiments.

The biometric scanning mechanisms 206 may be any biometric scanning device or application capable of sensing, obtaining, recognizing, or otherwise capturing a unique biometric 208 from the user 132. Accordingly, the biometric scanning mechanism 206 may include functional components for capturing biometric data related to a user's iris or eyes, voice, fingerprints, DNA, gait, facial structure and shape, ear structure and shape, heart rate, or any other type of biometric 208.

In a preferred embodiment, the fraud prevention application 128 requires the user 132 to submit at least two different types of biometrics 208 so as to provide a first biometric 236 and a second biometric 238. The user 132 may provide the biometrics 208 and any biometric data associated with the biometrics 208 using the biometric scanning mechanisms 206 included with or downloaded onto the user computing device 100, or a separate biometric scanning mechanism 206 that is connectable via wired or wireless connection with the user computing device 100.

It is an intended objective that when a user 132 is provided with or seeks to obtain a credit card 216 or a debit card 217 that the card issuer 218 requires the user 132 to submit two forms of biometric identifiers 208 that may be associated and registered with each credit card 216 or debit card 217. The user 132 may be required to submit biometrics 208, including at least a first biometric 236 and a second, back up biometric 238. Further, in a non-limiting embodiment, the user 132 may have a unique user account 240.

The user account 240 may be a unique user profile registered with the fraud prevention application 128 to identify the user 132 and any relevant information about the user 132's credit card 216, debit card 217, and stored biometric identifiers 208. The user 132 may need to login and provide either a password or other form of secure identification (e.g., either first biometric 236 or second biometric 238) in order to log into user 132's account 240. Further, in a non-limiting embodiment, the user 132 may be able to communicate with the card issuer 218 via secured, encrypted messages and view any information about the user 132's account for each credit card 216 and debit card 217 using the fraud prevention application 128 and accessing the unique user's 132 account. Such information for the credit card 216 and debit card 217 may include, but is not limited to, card number information, expiration dates, security codes, telephone numbers, addresses, name of user as shown on the credit card 216 or debit card 217, or any other relevant information or identifiers included on the credit card 216 or debit card 217. Further, in a non-limiting embodiment, because biometric identifiers 208 will be associated with each credit card 216 and debit card 217, it may be relevant to have one or more symbols included on the front of each credit card 216 and debit card 217 indicating as such that the credit card 216 and debit card 217 are tied to biometric identifiers 208 so that any third parties will be aware just by looking at the front or back of the credit card 216 or debit card 217 that further biometrics 208 will be required to activate and/or use the credit card 216 and debit card 217 at all times.

As shown in FIG. 2, it is an intended objective that the fraud prevention application may be used at all times with any vendor 220, whether onsite 242 or online 244. In some embodiments, the user 132 may have a physical credit card 216 or debit card 217 that may be used at an actual venue or onsite 242 source for vendor 220 (or other service provider). If the user 132 has a physical credit card 216 or debit card 217, the physical credit card 216 or debit card 217 may be entered or swiped through a credit card or debit card scanner/reader 210 onsite 242. Online 244 refers to the purchase or other use of credit card 216 and/or debit card 217 to purchase goods or services online or over an Internet network or other form of network. The user 132 may be asked to swipe their credit card 216 or debit card 217 through a card scanner/reader 210 that reads the relevant card details and information for that credit card 216 or debit card 217 and then that card information is transmitted online 244 to the online vendor 220. In other instances, the user 132 is asked to type in or otherwise enter using one or more input devices 106 of the user computing device 100 the card information and that card information is transmitted online 244 to the online vendor 220.

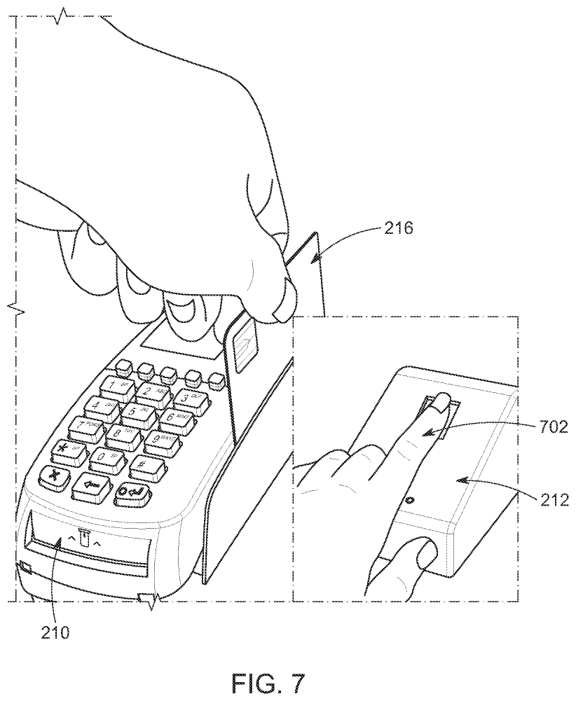

For onsite 220 and/or online vendors 224, there may be a card scanner/reading device 210 that is used to acquire or capture the relevant user and/or vendor information stored on the credit card 216 or debit card 217. The card scanner/reading device 210 may include a biometric reader/scanner 212 that can also process the first biometric 236 and/or second biometric 238 as provided by the user 132. For example, FIG. 7 shows an example of a physical card scanner/reading device 210 that may be used for a credit card 216 (or a debit card 217). A biometric scanner 212 may be connected either with a wired or wireless connection (e.g., over a network or via BLUETOOTH or another wireless connection) to the card scanner 210 such that when the credit card 216 is swiped or otherwise coupled with the card scanner 210 such that the credit card 216 information (e.g., credit card number, date of expiration, security codes) is acquired by the credit card scanner 210, the user 132 has to subsequently provide a biometric identifier 208 that has been associated with the credit card 216 (or debit card 217), such as a first biometric 236 and a second biometric 238. FIG. 7 shows the example of a finger 702 being used to provide a biometric identifier 208, which would be a unique fingerprint of the user 132 that has been associated with the credit card 216 and stored and registered with the card issuer 218 and with the user account 240.

It is noted that in some embodiments the card scanner 210 may be a physical device with buttons/selectors and/or other mechanisms for swiping or inserting a physical form of credit card 216 or debit card 217. This may include any type of card processing device used for credit cards 216 or debit cards 217, including but not limited to, magstripe readers, chip or EMV readers, contactless card readers, credit card readers that couple with POS (point of sale) applications, or any type of payment terminal that may capture credit card 216 or debit card 217 information. In other embodiments, the card scanner 210 may entirely be in the form of a computer application or website or some other digital format in which the user 132 can manually type in or input the information for the credit card 216 or debit card 217 using the user computing device 100 and/or fraud prevention application 128.

It has been thought that card fraud (e.g., credit and debit card fraud 202) and general identity fraud is more likely to occur for remote or online 240 purchases in which hackers are able to easily obtain personal card information and details from unsecured or unencrypted websites. For onsite 242 purchases, it has been traditional practice that vendors 220 may ask for some form of physical identification such as a driver's license, passport, or other official document that includes identifying information for the holder, including a photograph. However, lately, it has been observed that few vendors 220 ever ask for physical identification, so users 132 cannot rely on this measure to prevent frauds who have stolen a credit card 216 or debit card 217 from using these cards onsite 242. Accordingly, it is still necessary to have a system and application such as the fraud prevention application 128 that requires the use of biometric identifiers 208, including first biometric 236 and second biometric 238 prior to any activation and/or authorization of use, including for purchases, of credit card 216 or debit card 217 is allowed and approved by a card issuer 218 to the vendor 220, whether onsite 242 or online 244. The card issuer 218 may thus require the submission of a first biometric 236 from the user 132 matching the first biometric 236 stored in the fraud prevention application 128 and associated with the user account 240 before authorizing use of any kind of a credit card 216 or debit card 217. If the first biometric 236 fails to match for any reason, which may happen if there is a technical glitch or the like with the biometric reader 212 that may be integrated or connected with the vendor 220, then a second biometric 238 may instead be provided to the card issuer 218, wherein the second biometric 238 has also been stored and registered with the card issuer 218 when the credit card 216 or debit card 217 were first activated by the user 132 and stored with the user account 240.

In one or more non-limiting embodiment, for online vendors 244, the fraud application prevention application 128 may couple to the online website or other site associated with the online vendor 244 and provide the first biometric 236 and/or second biometric 238 before an online purchase or other use of the credit card 216 or debit card 217 is approved. In an alternative embodiment, any linked biometrics 236/238 may remain with the fraud prevention application 128 and the third party (e.g., vendors 220 or voting database 234 or voting locations 214) can access the application 128 to query if the linked biometrics 236/238 match and are the same at the time of comparison.

In this manner, the fraud prevention application 128 may be used to help minimize and entirely prevent card fraud 202 (fraud associated with unauthorized use of credit card 216 and/or debit card 217). Further, as shown in FIG. 2, the fraud prevention application 128 may further be useful in preventing voter fraud 204.

In a non-limiting embodiment, before the user 132 may vote in any federal 228, state 230, or local 232 election and receive a voting ballot 224 (or other voting tool), the user 132 must first register with a local voting precinct 222 according to the following method/procedure. The biometric identifiers 208 including but not limited to, the first biometric 236 and the second biometric 238, stored and/or otherwise accessible by the fraud prevention application 128 may be associated with the local voting precinct 222 associated with the user 132. A precinct or voting district, in the United States, is the smallest unit into which electoral districts are divided. Each user 132 is eligible to vote only in a certain identified precinct 222 usually based on the user 132's residential address. This is the case even if the user 132 is allowed to vote remotely using a remote voting ballot 224, such as is often the case with military members who may be deployed overseas at the time voting occurs for any federal 228, state 230, or local 232 election.

The local voting precinct 222 may thus associate the user 132's first biometric 236 and/or second biometric 238 with their voter identity. Further, in a non-limiting embodiment, the user 132 may be assigned a voter ID number 226 unique to the user 132. The user 132 or voter may be asked to provide both the voter ID number 226 and a first biometric 236 and/or second biometric 238 before being authorized to vote in a federal 228, state 230, or local 232 election. In a non-limiting embodiment, the voter ID number 226 is assigned to a voting precinct when the user registers to vote. It is noted that the voter ID number 226 may incorporate a combination of numbers or letters and may not be limited solely to numbers.

There may be one or more voting/polling locations 214 within the local voting precinct 222 where the user 132 is eligible to vote in a federal 228, state 230, and/or local 232 election. Each voting/polling location may include one or more physical devices, kiosks, stands, terminals, or any other type of tool or system that may incorporate one or more biometric readers 212 that can capture a user 132's biometric identifiers 208, such as a first biometric 236 and/or second biometric 238.

Further, in some embodiments, a physical voting device or system at the voting/polling location 214 having the biometric reader 212 may not be necessary. Rather, the user 132 may be eligible to vote remotely and online but may still be required to provide both the uniquely assigned voter ID number 226 and biometric identifiers 208. For example, the voting ballot 224 can be integrated or otherwise associated with the fraud prevention application 128 which includes biometric identifiers 208 that have already been stored or otherwise accessible by the fraud prevention application 128. To select any voting options associated with the voting ballot 224, the user 132 may need to enter or otherwise provide their unique voter ID number 226. The fraud prevention application 128 may be prompted to provide a first biometric identifier 236 and/or, if needed, a second biometric identifier 238 to the online voting ballot 224, prior to the voter/user 132 being authorized to vote via the voting ballot 224. Advantageously, whether or not the user 132 is located in a physical voting location 214 or is voting remotely, because the system requires use of the fraud prevention application 128 and the integrated biometrics 208, there is much less likely any chance of voter fraud 128 being committed or occurring due to the illegal activities of fraudulent voters.

It is noted that if biometrics 208 have not already been stored or are otherwise accessible by the fraud prevention application 128 prior to submitting for approval for a user 132 to vote in an election (e.g., federal 228, state 230, or local 232), the fraud prevention application 128 may be coupled with a biometric scanning mechanism 206 in the user computing device 100 that allows the user 132 to directly supply the relevant biometric identifiers 208 that have been associated and registered with the local voting precinct 222 and user's 132's voter identity.

Thus, the fraud prevention application 128 may help to prevent card fraud 202, voter fraud 204, and identity theft because of the requirement of using biometric identifiers 208 for any card usage or voting.

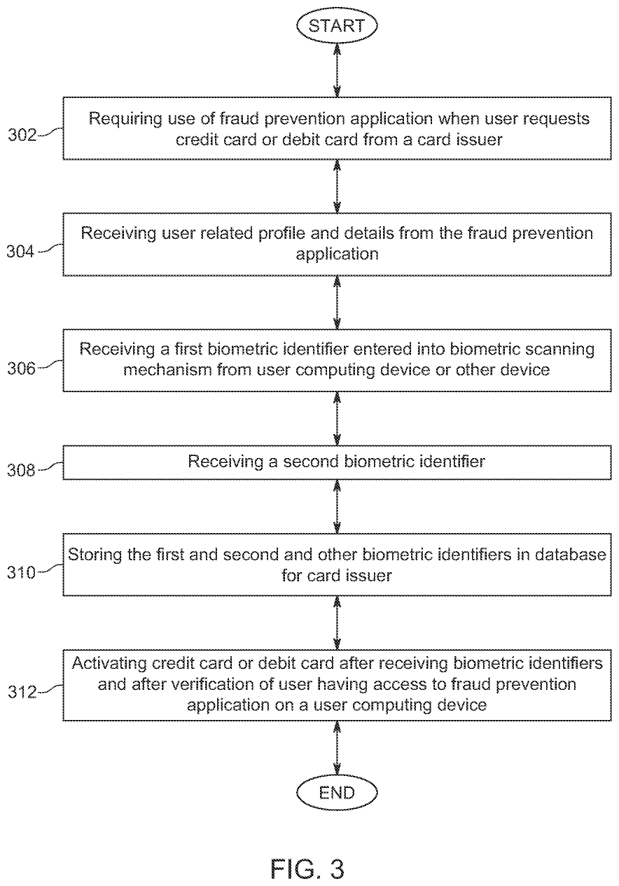

FIG. 3-6 provide exemplary flowcharts for exemplary methods/processes associated with the fraud prevention application 128 and other components shown in FIG. 2 and described above in one or more non-limiting embodiments.

FIG. 3 shows an exemplary flowchart for an exemplary process for activating a credit card 216 or debit card 217. At step 302, the process may begin by requiring the use of a fraud prevention application 128 when the user 132 first requests or is otherwise offered a credit card 216 or debit card 217 from a card issuer 218. At step 304, the card issuer 218 may receive user related account 240 and other details from the fraud prevention application 128. At step 306, the card issuer 218 may receive a first biometric identifier 236 entered or otherwise captured by a biometric scanning mechanism 206 associated with or otherwise connected to the user computer computing device 100 or another third party device. At step 308, the user 132 may provide a second biometric identifier 238 that may also be entered or otherwise captured by a biometric scanning mechanism 206 associated with or otherwise connected to the user computing device 100 or another third party device.

At step 310, the first biometric 236 and second biometric 238 may be stored or otherwise associated with one or more databases of the card issuer 218. At step 312, the activation of the credit card 216 or debit card 217 may only occur after the biometric identifiers 208 (e.g., first biometric 236 and second biometric 238) are received by and provided to the card issuer 218, and after verification of the user's account 240 being accessed by the fraud prevention application 128 on the user computing device 100.

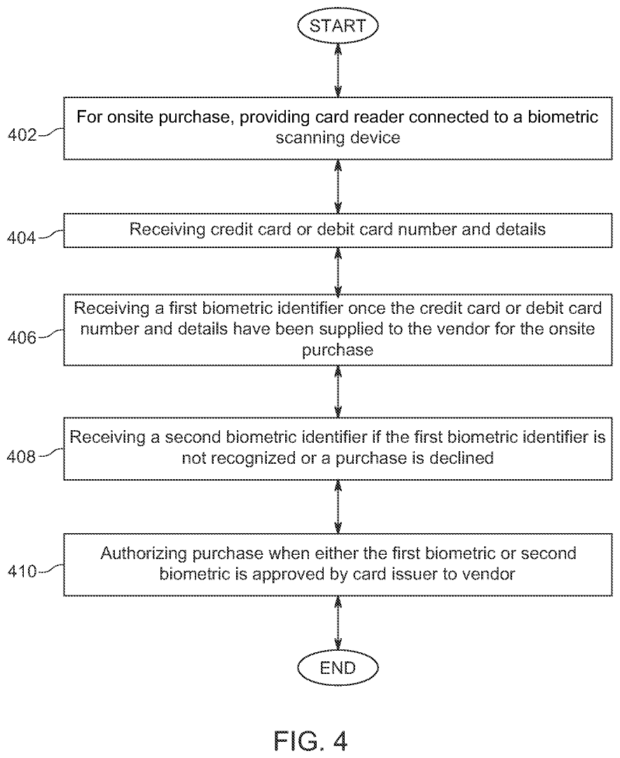

FIG. 4 depicts an exemplary flowchart for an onsite purchase or other use of a credit card 216 or debit card 217 with an onsite vendor (e.g., onsite vendor 242) by user 132. In a non-limiting embodiment, the process may begin at step 402 in which the user 132 is provided with a card reader 210 that includes or is otherwise connected to a biometric scanning device 206 and/or reader 212. At step 404, the card reader 210 may capture or otherwise receive the credit card 216 and/or debit card 217 information and details. At step 406, the user 132 may be prompted to provide a first biometric identifier 236 once the credit card 216 and/or debit card 217 information have been captured. At step 408, the user 132 may be prompted to provide a second biometric identifier 238 if the first biometric identifier 236 is not recognized or the purchase or other use of the credit card 216 or debit card 217 is declined. For steps 406 and 408, the card issuer 218 may receive the first biometric 236 and/or second biometric 238 data that is communicated to the card issuer 218 electronically through the integrated biometric scanning device 206 and/or reader 212 that is electronically, or wirelessly connected to the card issuer 218.

At step 410, the purchase or other use of the credit card 216 or debit card 217 may be authorized when either the first biometric 236 or the second biometric 238 is approved by the card issuer 218 to the onsite vendor 242.

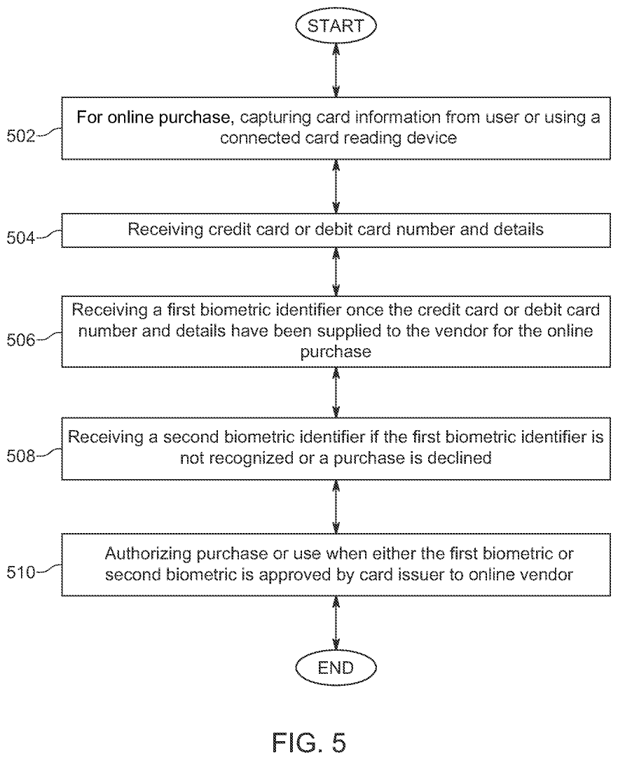

FIG. 5 depicts an exemplary flowchart for an online purchase or other use of a credit card 216 or debit card 217 with an online vendor (e.g., online vendor 244) by user 132. In a non-limiting embodiment, the process may begin at step 502 in which credit card 216 or debit card 217 is captured and supplied to an online vendor 244. This may happen according to a number of non-limiting methods and embodiments. The user 132 may input the credit card 216 or debit card 217 information into an authorized website, application, or other interface associated with the online vendor 244 and the purchase or use the user 132 is authorizing. Alternatively, there may be a card reader 210 that is connected to the online vendor 244 that the user 132 can use to capture the credit card 216 or debit card 217 information. Ultimately, at step 504, the card issuer receives the credit card 216 and/or debit card 217 details, including card number, expiration date, security code, qualifying address, and any other relevant details and information needed for use of the credit card 216 or debit card 217.

At step 506, prior to authorization of the purchase or other use via the credit card 216 or debit card 217, a first biometric 216 is transmitted to the card issuer 218 for approval of the purchase or other use with the online vendor 244. The first biometric 236 may be transmitted in a number of exemplary ways. In a first non-limiting embodiment, the fraud prevention application 128 that has stored or access to the first biometric 236 transmits to the online vendor 244 the first biometric 236. In another non-limiting embodiment, one or more biometric scanning mechanisms/devices 206 may be used so that the user 132 provides a first biometric 236 directly to the card issuer 218 rather than using the fraud prevention application 128 to provide a stored copy of the first biometric 236 that is stored or accessible by the fraud prevention application 128. The one or more biometric scanning mechanisms 206 may be connected to the card issuer 218 through either a wired, wireless, or other type of connection.

At step 508, if the first biometric 236 is not recognized or authorized or the purchase or use is otherwise declined, the user 132 may be prompted to provide a second biometric 238 to the card issuer 218. In a first non-limiting embodiment, the second biometric 238 may be transmitted from the fraud prevention application 128 to the card issuer 218 (e.g., transmitted a stored or otherwise accessible copy of the second biometric 238). In a second non-limiting embodiment, the second biometric 238 may be transmitted by the user 132 using one or more biometric scanning mechanisms 206 to directly provide the second biometric 238 in real time or near real time. The one or more biometric scanning mechanisms 206 may be connected to the card issuer 218 through either a wired, wireless, or other type of connection.

At step 510, the purchase or other use of the credit card 216 or debit card 217 may be authorized when either the first biometric 236 or the second biometric 238 is approved by the card issuer 218 to the online vendor 242.

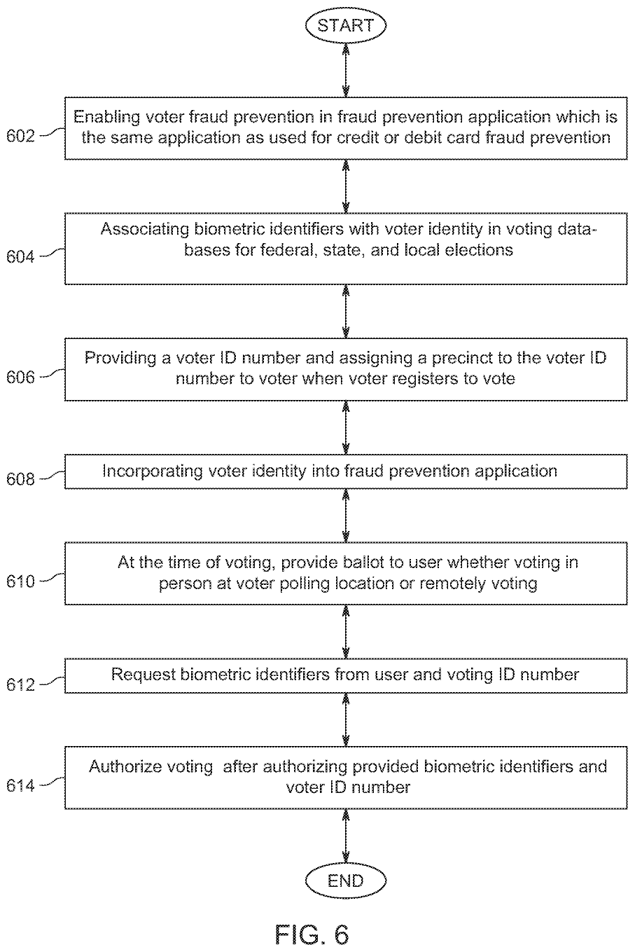

FIG. 6 is a flowchart for an exemplary method of preventing voter fraud using the fraud prevention application 128. At step 602, the process may begin with enabling voter fraud 204 prevention using the fraud prevention application 128, which is the same application as used to prevent credit or debit card fraud 202.

At step 604, the process may include associating biometric identifiers 208, such as first biometric 236 and second biometric 238 with the user 132's voting identity in voting databases 234 (e.g., associated with the local precinct 222) for federal 228, state 230, and local 232 elections. The biometric identifiers 208 may be transmitted as stored or otherwise accessible from the fraud prevention application 128 or may be transmitted or provided to the voting databases 234 or other relevant parties from one or more biometric scanning mechanisms that may be associated with the user computing device 100 or that are separate from the user computing device 100.

At step 606, the voter ID number 226 is provided to the user 132 and associated with the user 132's voting identity as well as associated or assigned to a particular voting precinct 222 when the user 132 registers to vote. At step 608, the fraud prevention application 128 may incorporate the voter identity of the user 132, including storing or registering the voter ID number 226 and relevant information about the user 132's assigned voting precinct 222. At step 610, the user 132 may be provided with a voting device/machine (e.g., such as at the voting location 214), which may include a biometric reader 212. The user 132 may vote in person or remotely in one or more non-limiting embodiment. In some embodiments, the ballot 224 may be a physical ballot provided to the user 132 onsite at the voting location 214. Alternatively, the ballot 224 may be an electronic ballot viewable using the fraud prevention application 128 from the user computing device 100 in some instances. At step 612, the user 132 is prompted to provide biometric identifiers 208, including first biometric 236 and/or second biometric 238 from the user 132 prior to submitting the ballot 224 or prior to voting. As noted above and similar to step 604, the biometric identifiers 208 may be transmitted as stored or otherwise accessible from the fraud prevention application 128 or may be transmitted or provided to the voting databases 234 or other relevant parties from one or more biometric scanning mechanisms that may be associated with the user computing device 100 or that are separate from the user computing device 100. Further, at step 610, in addition to the biometric identifiers 208, the user 132 may be required to further enter or otherwise provide a voting ID number 226.

At step 614, the user 132 may be authorized to vote after providing the necessary biometric identifier 208 and voter ID number 226. It is noted that similar to the card fraud prevention 202, the user 132 may first supply a first biometric 236 for voting authorization. If that first biometric 236 fails to be authorized or is declined, then the user 132 may be prompted to provide a second authorized biometric 238 associated with the user 132's voter identity.

Notably, the one or more systems described above provide many benefits and advantages over existing systems. The fraud prevention application 128, as described above in one or more non-limiting embodiments, integrates card fraud 202 and voter fraud prevention 204 using the same biometrics 208 integrated in the fraud prevention application 128.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or table of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

The embodiments were chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

What is claimed is:

1. A computer implemented method for card fraud prevention for an online purchase or use and voter fraud prevention, the computer implemented system comprising:
providing a fraud prevention application that is downloadable or stored on a user computing device;
capturing a first biometric and a second biometric using one or more biometric scanning mechanisms from a user, wherein the one or more biometric scanning mechanisms are connectable or otherwise interactable with the user computing device;
storing the first biometric and the second biometric in accessible storage associated with the fraud prevention application;
registering the first biometric and the second biometric with a card issuer for a credit card or a debit card upon activation of the credit card or the debit card, further comprising associating the first biometric and the second biometric with the credit card or the debit card;
upon request by the card issuer responding to a request to use the credit card or the debit card online for the online purchase or other use, providing to the card issuer the first biometric prior to authorizing the online purchase or other use of the credit card or debit card;
if the first biometric fails to be approved, providing to the card issuer the second biometric prior to authorizing the online purchase or other use of the credit card or debit card;
utilizing the fraud prevention application to prevent voter fraud by associating a voter identity for the use with the first biometric and the second biometric stored in the fraud prevention application, further comprising:
associating the first biometric and the second biometric with a voter ID assigned to the user;
providing a ballot to the user to vote in person or remotely;
when the first biometric provided matches with an entered voter ID, authorizing voting via the ballot; and
if the first biometric is not approved, providing the second biometric;
authorizing voting via the ballot upon matching of the entered voter ID and matching of the first biometric or the second biometric.

2. The computer implemented system of claim 1, wherein providing to the card issuer the first biometric prior to authorizing the online purchase or other use of the credit card or debit card upon request by a card issuer responding to a request to use the credit card or the debit card for the online purchase or other use further comprises:
transmitting from the fraud prevention application the first biometric to the card issuer.

3. The computer implemented system of claim 1, wherein providing to the card issuer the first biometric prior to authorizing the online purchase or other use of the credit card or debit card upon request by a card issuer responding to a request to use the credit card or the debit card online for an online purchase or other use further comprises:
transmitting the first biometric from the one or more biometric scanning mechanisms to the card issuer.

4. The computer implemented system of claim 1, providing to the card issuer the second biometric prior to authorizing the online purchase or other use of the credit card or debit card if the first biometric fails to be approved, further comprises:
transmitting from the fraud prevention application the second biometric to the card issuer.

5. The computer implemented system of claim 1, providing to the card issuer the second biometric prior to authorizing the online purchase or other use of the credit card or debit card if the first biometric fails to be approved, further comprises:
transmitting the second biometric from the one or more biometric scanning mechanism to the card issuer.

6. The computer implemented system of claim 1, wherein a user account is created and associated with the fraud prevention application.

7. The computer implemented system of claim 6, wherein information related to the credit card and the debit card is stored with and accessible from the user account.

8. The computer implemented system of claim 1, wherein the first biometric is associated with identifiers comprising fingerprints, eyes, voice, face, or ears of the user.

9. The computer implemented system of claim 1, wherein the second biometric identifier comprises a biometric identifier associated with fingerprints, eyes, voice, face, or ears of the user.

10. A computer implemented method for card fraud prevention for onsite purchases or use and voter fraud prevention, the computer implemented system comprising:
providing a fraud prevention application that is downloadable or stored on a user computing device;
capturing a first biometric and a second biometric using one or more biometric scanning mechanisms from a user, wherein the one or more biometric scanning mechanisms are connectable or otherwise interactable with the user computing device;
storing the first biometric and the second biometric in accessible storage associated with the fraud prevention application;
registering the first biometric and the second biometric with a card issuer for a credit card or a debit card upon activation of the credit card or the debit card, further comprising associating the first biometric and the second biometric with the credit card or the debit card;
upon request by the card issuer responding to a request to use the credit card or the debit card for an onsite purchase or other use, providing to the card issuer the first biometric prior to authorizing a purchase or other use of the credit card or debit card onsite;
if the first biometric fails to be approved, providing to the card issuer the second biometric prior to authorizing a purchase or other use of the credit card or debit card onsite;
utilizing the fraud prevention application to prevent voter fraud by associating a voter identity for the use with the first biometric and the second biometric stored in the fraud prevention application, further comprising:
utilizing the fraud prevention application to prevent voter fraud by associating a voter identity for the use with the first biometric and the second biometric stored in the fraud prevention application, further comprising:
associating the first biometric and the second biometric with a voter ID assigned to the user;
providing a ballot to the user to vote in person or remotely;
when the first biometric provided matches with an entered voter ID, authorizing voting via the ballot; and
if the first biometric is not approved, providing the second biometric;
authorizing voting via the ballot upon matching of the entered voter ID and matching of the first biometric or the second biometric.

11. The computer implemented system of claim 10, wherein providing to the card issuer the first biometric prior to authorizing the purchase or other use of the credit card or debit card upon request by the card issuer responding to a request to use the credit card or the debit card for the onsite purchase or other use further comprises:
transmitting from the fraud prevention application the first biometric to the card issuer.

12. The computer implemented system of claim 10, wherein providing to the card issuer the first biometric prior to authorizing the onsite purchase or other use of the credit card or debit card further comprises:
transmitting the first biometric from the one or more biometric scanning mechanisms to the card issuer.

13. The computer implemented system of claim 10, providing to the card issuer the second biometric prior to authorizing the purchase or other use of the credit card or debit card onsite if the first biometric fails to be approved, further comprises:
transmitting from the fraud prevention application the second biometric to the card issuer.

14. The computer implemented system of claim 10, providing to the card issuer the second biometric prior to authorizing a purchase or other use of the credit card or debit card onsite if the first biometric fails to be approved, further comprises:
transmitting the second biometric from the one or more biometric scanning mechanism to the card issuer.

15. The computer implemented system of claim 10, wherein a user account is created and associated with the fraud prevention application.

16. The computer implemented system of claim 15, wherein information related to the credit card and the debit card is stored with and accessible from the user account.

17. The computer implemented system of claim 10, wherein the first biometric identifier comprises fingerprints, eyes, voice, face, or ears of the user.

18. The computer implemented system of claim 10, wherein the second biometric identifier comprises fingerprints, eyes, voice, face, or ears of the user.

19. A computer implemented system for card fraud prevention and voter fraud prevention, the computer implemented system comprising:
a computing device having a display screen;
one or more memory; and
one or more processors configured to:
provide a fraud prevention application that is downloadable or stored on a user computing device;
capture a first biometric and a second biometric using one or more biometric scanning mechanisms from a user, wherein the one or more biometric scanning mechanisms are connectable or otherwise interactable with the user computing device;
store the first biometric and the second biometric in accessible storage associated with the fraud prevention application;
register the first biometric and the second biometric with a card issuer for a credit card or a debit card upon activation of the credit card or the debit card, further comprising associating the first biometric and the second biometric with the credit card or the debit card;
upon request by a card issuer respond to a request to use the credit card or the debit card online for the online purchase or other use, provide to the card issuer the first biometric prior to authorizing the online purchase or other use of the credit card or debit card;
if the first biometric fails to be approved, provide to the card issuer the second biometric prior to authorizing the online purchase or other use of the credit card or debit card;
utilize the fraud prevention application to prevent voter fraud by associating a voter identity for the use with the first biometric and the second biometric stored in the fraud prevention application, further comprising:
associate the first biometric and the second biometric with a voter ID assigned to the user;
provide a ballot to user to vote in person or remotely;
when the first biometric provided matches with an entered voter ID, authorize voting via the ballot; and
if the first biometric is not approved, provide the second biometric; and
authorize voting via the ballot upon matching of the entered voter ID and matching of the first biometric or the second biometric.

20. The computer implemented system of claim 19, wherein the first biometric identifier comprises fingerprints, eyes, voice, face, or ears of the user.
